(19) United States
(12) Patent Application Publication
(10) Pub. No.: US 2003/0055745 A1
(43) Pub. Date: Mar. 20, 2003

(54) Electronic commerce system and method using live images of online shopping mall on the internet

(76) Inventor: Sug-Bae Kim, Daegu-shi (KR)

Correspondence Address: FRANK R. OCCHIUTI, Fish & Richardson P.C., 225 Franklin Street, Boston, MA, 02110-2804, US

(21) Appl. No.: 10/289,764

(22) Filed: Nov. 7, 2002

Related U.S. Application Data
(63) Continuation of application No. PCT/KR01/00761, filed on May 10, 2001.

(30) Foreign Application Priority Data
May 10, 2000 (KR) 2000-26135

(51) Int. Cl. G06F 17/60

(52) U.S. Cl. 705/26

(57) ABSTRACT

The invention relates to an electronic commerce system using live images of virtual space on the internet and a method of utilizing the same, in which an online shopping mall is established by inputting live images captured by a plurality of cameras set up in an actual shopping mall and mapping link information in the live images, so that consumers can directly participate in electronic commercial transactions, communicating with sales clerks of the live images by phone or computer on the interact as well as checking around market situations on the real-time basis.

### BACKGROUND OF THE INVENTION

1. Filed of the Invention

The present invention relates to an electronic commerce system using live images of virtual space on the interact and method for the same, and more particularly to an electronic commerce system using live images of virtual space on internet and a method for the same, in which an online shopping mall is established by inputting live images captured by a plurality of cameras set up in an actual marketing space for consumers to directly participate in electronic commercial transactions, checking market situations on the real-time basis.

2. Description of the Prior Art

Computer and other information communication systems are being developed rapidly enough not to easily predict technological progress and changes. Nobody cannot foresee when, where or what kind of new technological breakthrough will come to surprise the world. Particularly, a great advance has been made in the cyber space beyond people's imagination. Internet education, conference, exhibition, medical treatment, commercial transactions have recently started in the cyber world. A number of high-tech information communication technologies have been applied to many aspects of people's life, reminding that we do not live in an industrial society, but in an information society.

Recently, electronic commerce systems on the internet and on-line shopping malls have drawn attentions and concerns of many nations and global enterprises all over the world. The online shopping malls have been advantageous in many aspects of business such as advertisement of products, payment approval and distribution of digital products regardless of time, place or distance, so that consumers can save time, enjoying conveniences in purchasing products. In addition, enterprises have been able to cut down cost by reduction in product distribution steps and improve publicity activities in a low cost. As a result, both of the consumers and enterprises started to pay greater attention to the electronic commerce systems and the online shopping malls.

In addition, a great success of some on-line shopping malls like “Amazon. Com” or others has become a major cause of a rapid expansion and growth of shopping malls on the internet, so that those successful web shopping malls have not only improved consumer's reliability, but also boosted enterprises' confidence in success of internet business.

Each internet shopping mall described above has been established by constructing at a home page of an enterprise in the virtual space, displaying text and graphic information and price on products, and inducing consumers to participate electronic transactions through a payment approval system with a credit card or an online payment authorization system.

However, instead of only purchasing a desired product by getting in touch with URL of a shopping mall, consumers expect to have an opportunity to buy a variety of goods, browsing around the products displayed at a number of corners of the shopping mall as they go shopping in traditional manners.

In this regard, homepages of internet shopping malls have generally provided only two dimensional text and graphic information on products without making consumers entertained or excited about their shopping experiences as they feel in the actual shopping malls crowded with people eager to buy goods. Besides, the internet shopping malls have not filly satisfied consumers in that there is no shopping opportunity to buy goods on the spur of the moment they happen to find out a nice product at a shop as they walk by.

In addition, the internet shopping malls have not completely resolved consumers' discomfort about general electronic commercial transactions in the cyber space.

### SUMMARY OF THE INVENTION

Therefore, it is an object of the present invention to solve the aforementioned problems and provide an electronic commerce system using live images of virtual space on the internet and a method for the same, in which an online shopping mall is established by inputting live images captured by a plurality of cameras set up in virtual space for consumers to directly participate in electronic commercial transactions by communicating with clerks shown in the live images by phone or computer on the internet as well as checking market situations on the real-time basis.

In order to accomplish the aforementioned object of the present invention, there is provided an electronic commerce system using live images of virtual space on the internet comprising:

a plurality of cameras set up in roads or stores of an actual shopping mall;

an image input unit for receiving images captured and output from the cameras;

a web server for receiving live images of cameras set up at the places selected by consumers getting in touch with the shopping mall on the internet, mapping link information in the live images and providing it through the internet communication system.

In addition, telephone numbers are also provided for consumers to directly communicate with a sales person working at the actual shopping mall.

The aforementioned link information includes: all the commercial transaction information on the products displayed at a predetermined place of an live image; information on a camera to be selected to show a predetermined part of the shopping mall in the live image; and information on the location of a predetermined product.

Furthermore, the image input unit receives live images from a plurality of cameras through a cable or wireless networking system.

In addition, there is also provided a method for utilizing the electronic commerce system using live images of virtual space on the internet comprising the steps of:

getting in touch with a web server on the interact (step A);

allowing a consumer to receive a live image of a camera set up to show a place of a shopping mall as he or she selects (step B);

mapping link information in the live image (step C);

returning to step B to move to another place of the shopping mall, or displaying all commercial transaction information in accordance with the link information (step D) when the consumer selects a predetermined position of the live image; and

completing a commercial transaction with the consumer according to all the relevant commercial transaction information (step E).

At this time, all the commercial information also includes a telephone number for consumers to directly get in contact with sales clerks working in the actual shopping mall.

In the present invention thus constructed, consumers enjoy shopping by selecting live images of specific places on the internet to directly browse around all the products actually displayed in a shopping mall, obtaining all the detailed information on products they are interested in purchasing, and completing all the steps of online transactions between two parties between consumers and online merchandisers.

### BRIEF DESCRIPTION OF THE DRAWINGS

Objects and aspects of the invention will become apparent from the following description of a preferred embodiment with reference to the accompanying drawings in which:

FIG. 1 is a block diagram for illustrating an electronic commerce system using live images of virtual space on the interact in accordance with the present invention; and

FIG. 2 is a flow chart for illustrating a method of an electronic commerce system using live images of virtual space on the internet in accordance with the present invention.

### DETAILED DESCRIPTION OF THE PRESENT INVENTION

Objects and aspects of the present invention will become apparent from the following detailed description of a preferred embodiment with reference to the accompanying drawings.

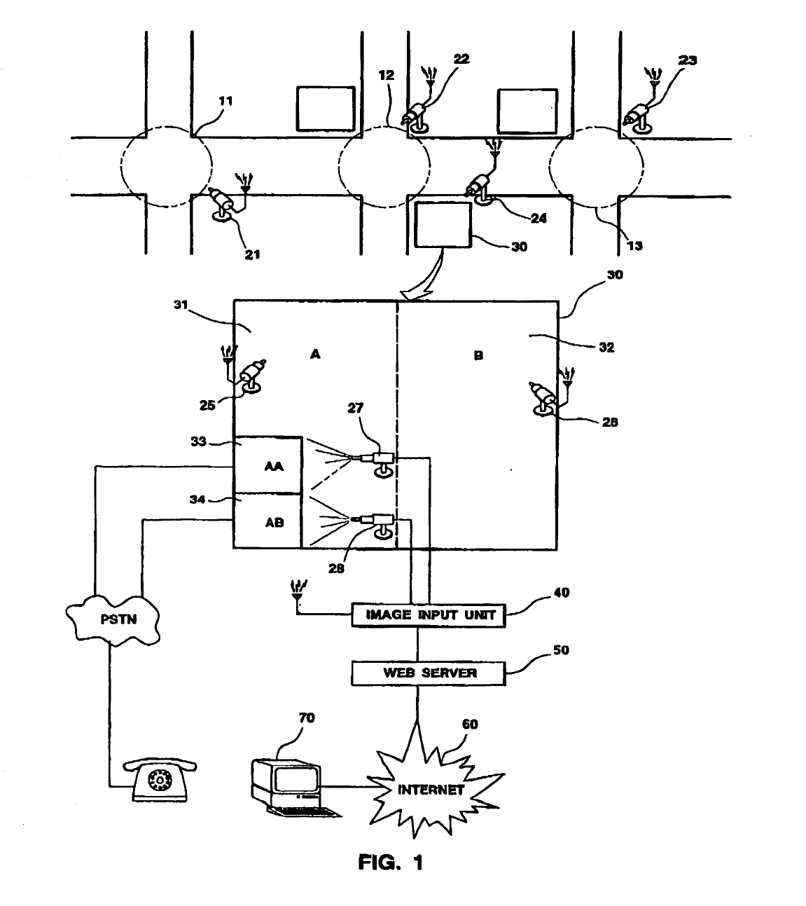

FIG. 1 is a block diagram for illustrating an electronic commerce system using live images of virtual space on the internet in accordance with the present invention.

As shown above, the first through third cameras 21, 22, 23 are set up at the first through third intersections 11, 12, 13 along a road close to a department store of a shopping mall. Besides, the fourth through sixth cameras 24, 25, 26 are respectively set up in the front side, in hall A 31 and in hall B 32 of the-department store 30. In addition, the seventh and eighth cameras 27, 28 are respectively installed for zooming up shop AA 33 and shop AB 34.

In addition, telephones are provided in both of shops AA and AB 33, 34 for enabling consumers to directly communicate with clerks.

Furthermore, the electronic commerce system using live images of virtual space on the internet also comprises: a plurality of cameras set up in a shopping mall of virtual space; an image input unit 40 for inputting images captured and output through cable or wireless networking system from the first through eighth cameras 2128 set up at a plurality of places; and a web server 50 for receiving from the image input unit 40 live images of camera set up at the places selected by consumers 70 getting in touch with the shopping mall 60 on the internet, mapping link information and providing it through the internet communication system.

At this time, the web server 50 of the virtual space provides its own data base storing all the detailed information on shops, products and members to be involved in the commercial transactions on the internet such as all necessary text and graphic information on the live images at the same time.

The aforementioned link information means that information on selectively linking the department store 30 with the third camera 23 set up in front of the department store 30 is transmitted if a consumer clicks his or her mouse onto the department store 30 of the live image captured and input from the second camera 22 of the second intersection 12. If a mouse is clicked onto the product of the live image input from the eighth camera 28 which zooms up shop AB 34 of hall A 31 of the department store 30, the product of the live image is immediately linked to display all the commercial information relevant to the product such as detailed description, ordering method and telephone number to get in contact with a sales clerk.

Also, the link information also means other text information such as the location of a camera outputting the live image displayed at the computer monitor and that of the department store or a desired product.

The aforementioned image input unit 40 is constructed to receive the live images captured by the first through eighth cameras 21˜28 through cable or wireless networking system.

Also, the image input unit 40 is also constructed to receive the live images input from a plurality of cameras set up at a plurality of places, and transmit them to the web server 50.

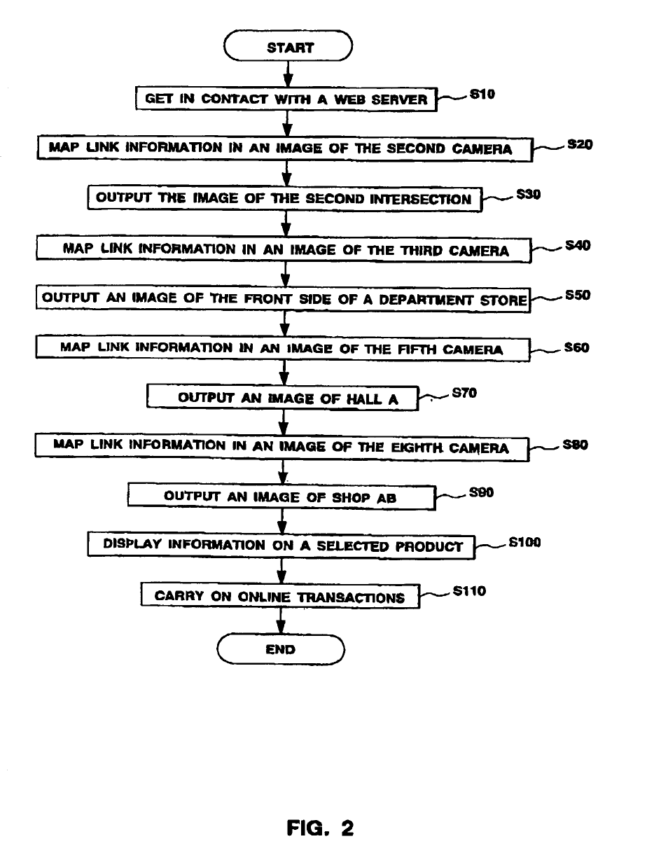

Next, a method for utilizing the electronic commerce system using live images of virtual space on the internet will be described with reference to a flow chart shown in FIG. 2.

First of all, a consumer 70 gets in contact with a web server 50 on the internetworking system 60 (S10). Then, a verification and approval process is performed for the consumer.

After completion of the verification and approval process, an image showing a predetermined road is displayed to allow the consumer to choose one of the first through third intersections 11, 12, 13, for instance, the second intersection. Then, the image captured by the second camera 22 of the second intersection 12 is input from the image input unit 40. At this time, link information is mapped in the image input from the second camera 22 (S20), and the image of the second intersection 12 having link information is output (S30). At this time, if the consumer 70 clicks his or her mouse onto the department store 30 displayed in the image of the second intersection 12, the link information mapped in the image of the department store 30 selectively links with the third camera 23 to zoom up and output the department store 30. Then, another link information is mapped in the image output from the third camera 23 (S40) to show all the images of the department store 30 to the consumer 70 (S50).

If the consumer 70 clicks hall A 31 in the image showing the internal part of the department store 30, the fifth camera 25 revealing an image of hall A 31 is selected. Then, the relevant link information is mapped in the image captured by the fifth camera 25 (S60) to show an image of hall A 31 (S70). If shop AB 34 is further selected in the image of hall A 31, the eighth camera 28 zooming up and taking an image of shop AB 34 is selected. Then, the relevant link information on detailed description of products is mapped in the image of shop AB 34 and products captured by the eighth camera 25 (S80), which outputs the image of shop AB 34 having the link information (S90).

If the consumer 70 selects a product displayed in shop AB 34, all the information relevant to the product is provided to the consumer 70 (S100). In other words, all the information necessary for electronic commercial transactions such as characteristics of the product, purchasing method, payment approving procedure, direct phone number is linked to enable the consumer to conveniently buy the product (S110). At this time, the consumer may dial the number displayed on the computer monitor to directly communicate with the sales clerk actually working in the shop.

Even if the department store is presented in the embodiment of the present invention described above, a number of cameras can be set up along the roads of the shopping mall and inside all the shops participating at the electronic commercial activities to link all the detailed information, so that consumers can purchase products and enjoy shopping on the internet regardless of time or distance with pleasure just like actually visiting and shopping in stores.

As described above, there is an advantage in the electronic commerce system using live images of virtual space on the internet and a method for utilizing the same, in which an online shopping mall is established by inputting live images captured by a plurality of cameras set up in an actual shopping mall and mapping link information in the live images, so that consumers can directly participate in electronic commercial transactions, communicating with clerks of the live images by phone or computer on the internet as well as checking around market situations on the real-time basis.

In addition, there is another advantage in the electronic commerce system using live images of virtual space on the internet in that all commercial areas and shops can be viewed on the internet to prevent robbery or other disastrous accidents.

Having described a preferred embodiment of the invention with reference to the accompanying drawings, it is to be understood that the invention is not limited to the aforementioned precise embodiment, and that various changes and modifications may be effected therein by one skilled in the art without departing from the scope or spirit of the invention as defined in the appended claims.

What is claimed is:

1. An electronic commerce system using live images of virtual space on the internet comprising:
a plurality of cameras set up in roads or stores of an actual shopping mall;
an image input unit for receiving images captured and output from the cameras;
a web server for receiving live images of cameras set up at the places selected by consumers getting in touch with the shopping mall on the internet, mapping link information in the live images and providing it through the internet communication system.

2. The system, as defined in claim 1, wherein the link information includes: all the commercial transaction information on products displayed at a predetermined place of an live image; information on a camera to be selected to show a predetermined part of the shopping mall in the live image; and information on the location of a predetermined product.

3. The system having the link information, as defined in claim 2 or 5, wherein the commercial transaction information includes telephone numbers so that consumers can directly communicate with a sales person over the phone.

4. The system, as defined in claim 1, wherein the image input unit receives live images from a plurality of cameras through a cable or wireless networking system.

5. The system, as defined in claim 1, wherein a telephone is additionally installed at each shop for consumers to directly communicate with sales persons.

6. A method for utilizing the electronic commerce system using live images of virtual space on the internet comprising the steps of:
getting in touch with a web server on the internet (step A);
allowing a consumer to receive a live image of a camera set up to show a place of a shopping mall as he or she selects (step B);
mapping link information in the live image (step C);
returning to step B to move to another place of the shopping mall, or displaying all commercial transaction information in accordance with the link information (step D) when the consumer selects a predetermined position of the live image; and
completing a commercial transaction with the consumer according to all the relevant commercial transaction information (step E).
